(19) United States
(12) Patent Application Publication
(10) Pub. No.: US 2017/0183109 A1
(43) Pub. Date: Jun. 29, 2017

(54) Multi-purpose expandable complex providing maintenance, manufacturing, assemblage complex with external space dock

(71) Applicant: John Aylmer, Winter Park, FL (US)

(72) Inventor: John Aylmer, Winter Park, FL (US)

(21) Appl. No.: 14/998,744

(22) Filed: Feb. 9, 2016

Related U.S. Application Data
(63) Continuation of application No. 62/177,113, filed on Mar. 5, 2015.

(51) Int. Cl. B64G 1/64; B64G 1/40; B64G 1/54; B64G 1/10; B64G 1/48; B64G 1/14

(52) U.S. Cl. CPC B64G 1/646; B64G 1/48; B64G 1/14; B64G 1/543; B64G 1/105; B64G 1/1078; B64G 1/408; B64G 2001/1064; B64G 2001/1092; B64G 2004/005

(57) ABSTRACT

This present invention describes initial sequential methods for constructing and placing into operation a multi-purpose maintenance complex and a space dock in high geosynchronous orbit. This is dual function complex that can provide a orbital platforms to a commercial profitable enterprise or to the Department of Defense (DoD) to enhance their capabilities. A complex will have the capability to fabricate, assemble, test, and place into full operation any size orbital and planetary surface complexes and spacecraft. DoD mission capabilities embracing satellite repairs, research, national security and deterrence, space junk disposal support and other services while in orbit.

### CROSS-REFERENCE TO RELATED APPLICATIONS

This application claims are divisional and benefits of U.S. Provisional Application Ser. No. 62/175,253 filed on 12 Feb. 2015 and which is hereby incorporated by reference in its entirety; U.S. Provisional Application Ser. No. 62/282,148 filed on 16 Jul. 2015 and which is hereby incorporated by reference in its entirety;

### FEDERALLY SPONSORED RESEARCH OR DEVELOPMENT

Does not apply

### JOINT RESEARCH AGREEMENTS

Does not apply

### SEQUENCE LISTING

Does not apply

### STATEMENT REGARDING PRIOR DISCLOSURES

Does not apply

### BACKGROUND OF THE INVENTION

For better than a decade there have been many space colonization advocates and groups who have proposed, speculated, and conceptually designed vast space and planetary settlements; embracing a shared drive to have a sustainable, profitable, industrialization, mining and militarization expansion in deep space. Many patents have been written based reusing or refining previous NASA concepts which are not commercially viable or sustainable. The building of space or planetary colonies using current capabilities which is employing a 1962 launch style launch system of carrying 5 to 10 tons aloft one way. This approach presents huge financial, technological and economic challenges.

This present invention baseline [of] a core foundation [for] an aggressive enmasse choreographed engineering application of logistics, simulation and training, standardization of components, sustainability, robotics, and a robust trans-orbital cargo transportation pipeline. This pipeline supported by a fleet of Transorbital Freight Carriers 31 at FIG. 17 provides an enmasse and uninterrupted 24/7/365 infusion of all types of supplies and personnel. The said carrier has the capability is landing at any designated 8,000 feet or greater runaway and flies under FAA guidelines. NASA Space Shuttle concept was to support this type of operation and now abandoned as uneconomical for commercial for-profit applications.

This present invention presents a paradigm shift to improve on their planned NASA and commercial approaches for space exploration and planetary. By adopting this present invention and related applications, enables NASA and commercial entities to foster quicker for-profit operations and enables growth to unlimited new business ventures. From this initial orbital manufacturing complex FIG. 1 and FIG. 1A supported by trans-orbital freight carriers FIG. 9, the creation of independent and self-sufficient infrastructures for heavy industry, tourism, and space or planetary settlements are achievable. Any complex and deep space mining or planetary settlements must provide all materials and life support needed for hundreds to thousands of humans. Life support requires water and oxygen production, livestock, farming, prisons, etc. in order to independently survive in environment unsympathetic to human life and equipment.

### FIELD OF INVENTION

The present invention enables the creation and then operational capabilities for an orbital expandable complex which facilitating manufacturing, spacecraft and satellite maintenance and shipyard services and capable of being moved to support planetary and deep space exploration or mining location.

### DESCRIPTION OF DRAWINGS (15)

FIG. 1: An isometric drawing of the entire Multi-Purpose Complex.

FIG. 1A: An isometric drawing of the Space Dock Arm and Space Dock Testing Facility attached to the Multi-Purpose Complex.

FIG. 2: A top view of the floor plan of a typical Multi-Purpose Complex.

FIG. 2A: An isometric cut away drawing of a debris deflection shield, radiation shielded walls and maintenance corridor within a typical Multi-Purpose Complex.

FIG. 3: A pictorial overview of a logistics process flow tasks for transport of building materials from a manufacturer to a trans-orbital freight carrier.

FIG. 4: A pictorial overview of a delivery of materials and construction process flow tasks in building the original material handling and fabrication facility that will build the Multi-Purpose Complex.

FIG. 5: Isometric views of autonomous building devices and typical methods for orbital modular construction

FIG. 5A: A front and side views of a conceptual material handling drone used to float materials to and around to a in-situ building site

FIG. 6: an isometric view of the 8 facilities being initially mated together comprising the

Building Group A.

FIG. 6A: an isometric view of the final stage of mating Building Group A becoming the fabrication and assemblage facilities of the Multi-Purpose Complex

FIG. 7: an isometric view of the 8 facilities being initially mated together comprising the Building Group B which performing maintenance, overhauling, inventory and office functions

FIG. 7A: an isometric of the final stage of mating Building Group B being to Building Group A of the Multi-Purpose Complex

FIG. 8: an isometric view of the initial stage of mating Building Group C to the Building Group B becoming the hanger facilities of a Multi-Purpose Complex. The initial stages of the mating Building Groups D, E, and F together becoming the lodging and dining facilities of a Multi-Purpose Complex.

FIG. 8A: an isometric view of a completely mated Building Group C, D, E and F which becomes the operational Multi-Purpose Complex of FIGS. 1 & 1A

FIG. 9: an isometric view of a trans-orbital freight carrier and an intra-orbital and planetary Space Barge.

### DESCRIPTION OF THE [PRESENT] PREFERRED EMBODIMENTS

This present invention describes initial sequential methods for transporting, constructing and placing into operation a maintenance, manufacturing, fabrication and space dock complex in high geosynchronous orbit. This is dual function complex that can provide a orbital platforms to a commercial profitable enterprise or to the Department of Defense (DoD) to enhance their capabilities. A complex will have the capability to fabricate, assemble, test, and place into full operation any size orbital and planetary surface complexes and spacecraft. DoD mission capabilities embracing satellite repairs, research, national security and deterrence, space junk disposal support and other services while in orbit.

When fully operational, this manufacturing complex 1 & 2 is a massive scale when comparing it to the current International space station 13. Although massive, it is modular built over a period of time with a phased schedule and only accomplished with the introduction of trans-orbited freight carrier [patent application 62/176,253 filed on 12 Feb. 2015].

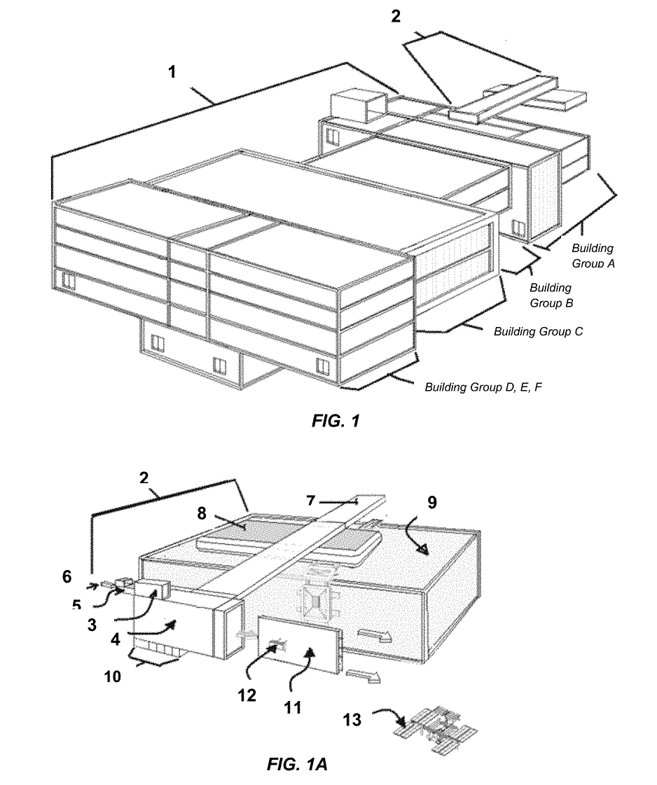

In the preferred first embodiment, a completed multi-purpose expandable maintenance, manufacturing complex 1 exhibited at FIG. 1. Whereas, FIG. 1A displays the rear of this complex 2 is where the location of fabrication and assemblage modules 3, 4 and the space dock arm 7. The said space dock arm 7 with an attached final testing module 8. Below these said structures is a very large facility module [in gray] 9 being readied for space trials and customer delivery. Equally, said space dock arm 7 is capable of securing more than one a large spacecraft, facility module or planetary structures at a given time. The complex 1, 2 requires an assortment of plug and play life support management systems; compact fusion reactor; and waste management modules. These modules are provided to sustain long-term human habitation.

The building of very large spacecraft, facilities module and even this complex requires hands on experience in shipbuilding with the ability to manage an automated coordinated manufacturing and assemblage shipbuilding process flow. On earth, the said shipbuilding process flows are well established with large capital equipment investments. The said orbital construction processes are new and challenging requiring the development of new robotic material handling devices, ground control systems, training and simulations, various procedures and software to support construction tasks and material handling in zero gravity or later combined with artificial gravity.

FIG. 1A exhibits a notional orbital shipbuilding process that flows thru several complex modules. The process begins with a space barge 6 delivering raw materials or assorted components to the off-loading bay 5. After off-loading, the incoming materials are moved to the pre-assembly and inventory modules 3 for classification and scheduling. When components and materials are required, they are passed to the final sub-module component assemblage area 4. Upon completing a sub-module component 11, it is removed from the assemblage bay 4 by a space tug 12 and floated to the space dock 7.

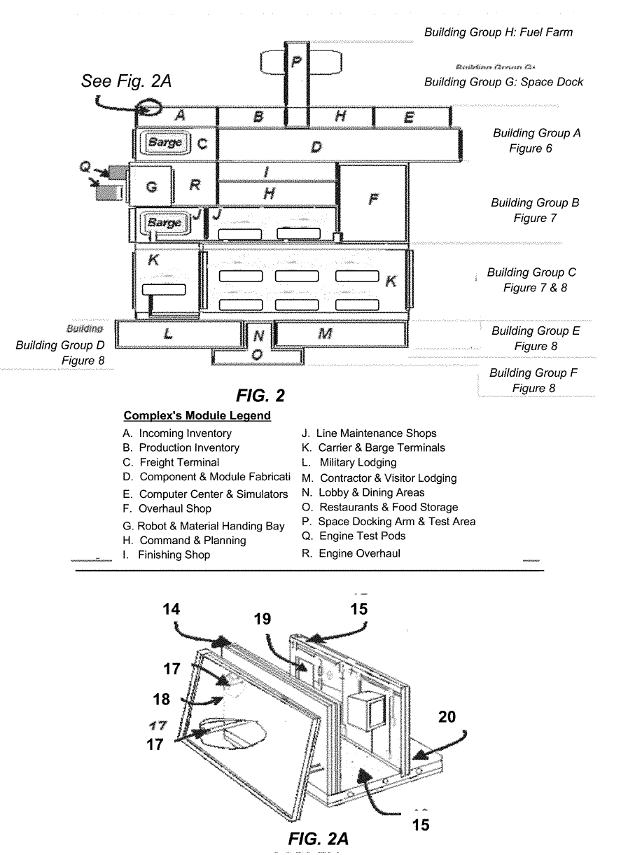

In the preferred second embodiment of this present invention reveals a generic floor plan of this specific complex 1. A generic floor plan diagram is provided at FIG. 2 provides suggestive locations of these various work spaces with a legend showing suggested placement of these spaces. Any complex is comprised of any number of connected modules and when delivered a module is empty box or shell. It is to be later outfitted and equipped then made operational by its user. Any combination, placement or development options are available.

Looking on the right side of this complex's generic floor plan configuration, a suggested build sequence is identified with Build Groups A through F highlighted at FIG. 1 and FIG. 2. These suggested sequenced groups are important because it is not economically not feasible and challenging limited resources to build this entire complex at one time. Rather, sequenced first is Build Group A. When completed and operational, Group A is responsible for the fabrication, assemblage and test facilities to complete this complex. After this entire orbital complex is completed and operational, it functions as a full service shipbuilding yard facility 2 with a space dock arm 7 having capabilities to build, repurpose, or maintain any complex, facility and/or spacecraft.

In the preferred third embodiment, a generic structural wall and floor component inherit to all modules and spacecraft. Presently, existing spacecraft and space habitants are they are minimally protected from radiation. With the improvements from this present invention, the wall systems depicted at FIG. 2A have an external outer wall systems 14 which is approximating 6-foot thick with an inner wall systems 15 approximating 3-foot thick. Together, these walls are designed to negate radiation and self sealing. Between the walls 14 and 15, a maintenance passageway 16 is accessible thru an air lock door 19 permits all maintenance to be done within a facility, complex or spacecraft eliminating the need for dangerous maintenance spacewalks. Where needed, a hydraulically-lifted 17 deflector shields 18 can be added to any internal module to deflect small debris. Equally, the floors and doors share the same radiation protection to the humans, animals, fish and all equipment.

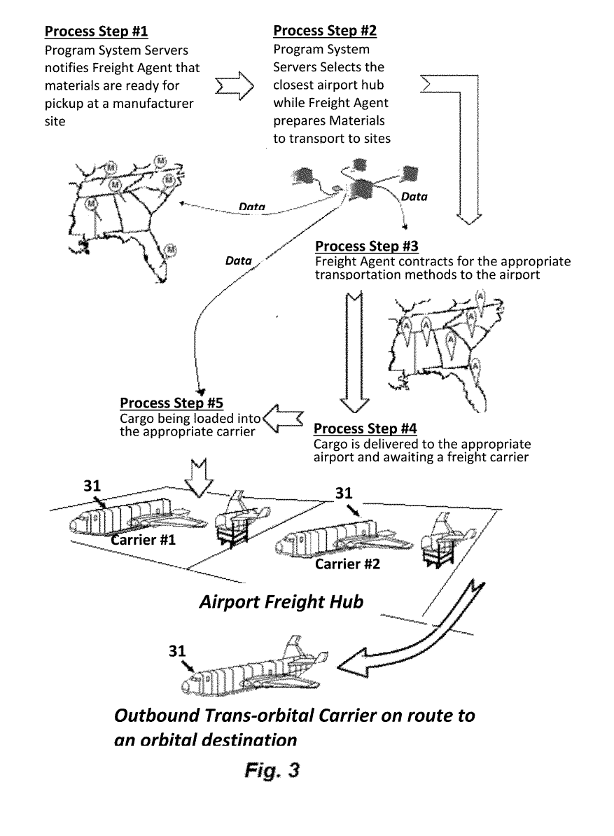

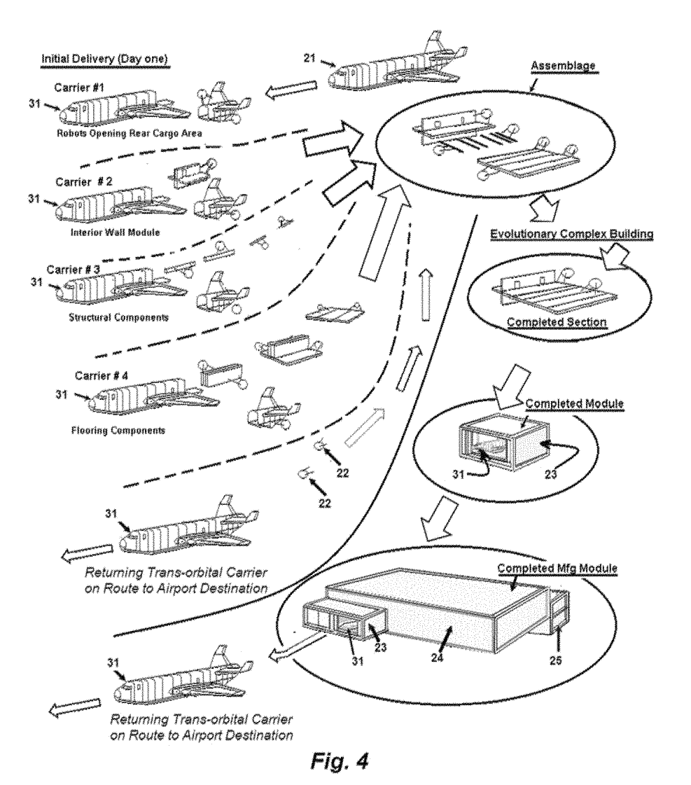

The said multi-purpose complex 1, 2 is depicted as a fully operational. Notwithstanding, the actual building and sustainment efforts of this complex are essential embodiments of this present invention. These embodiments embrace a fully operational trans-orbital transportation pipeline FIG. 3 and a transportation freight hub FIG. 4x are instrumental in managing incoming enmasse' cargo to build this complex. The description of apparatus and sustainment pipelines are disclosed under patent applications Nos. 62/176,253 and 62/282,148 respectively.

In the preferred fourth embodiment, a full utilization of existing in-situ ground freight transportation systems that capitalizes on existing engineering proficiency coupled with the vast resources of freight carrier corporations, similar to FedEx or UPS filed under U.S. Pat. No. 7,293,707 B2 dated Nov. 13, 2007 and U.S. Pat. No. 7,761,348 B2 dated Oct. 20, 2010. These corporations provide two essential capabilities (a) provide proven rapid and timing deliveries between all project suppliers and manufacturers supplies components to achieve these orbital builds FIGS. 1, 1A 4; (b) to meet the strict timing requirements of preparing manufacturers' components for delivery; transportation and delivery of these components to the final ground destination at the freight hub at transorbital airport FIG. 3; and (c) turn over components and cargo manifests to the loadmaster of transorbital freight aircraft FIG. 4. By utilization and contracting these mega freight carrier corporations, this invention embraces their use of their own patents U.S. Pat. No. 6,266,008 B1 dated Jul. 24, 2001, and employ other related patents for freight movement and inventory management.

This fourth embodiment introduces and requires sustainment of a dedicated fleet of transorbital freight carriers 31 filed under patent application 62/176,253 dated Feb. 12, 2015. A principal carrier design requirements are that it (a) can take off and land at an 8,000+ foot commercial runaway; (b) fly within FAA flight and weather regulations; (c) maximize the use of existing readily available technicians, software, and components—such as simulators, jet engines and rockets; (d) reconfigured for orbital insertion or returning earth; (e) sustain a rigorous maintenance schedule; (f) carrying approximately 60+ tons of cargo and passengers; and the fleet can maintain a finite flight schedule of 24/7/365 to the designated freight hub destinations. A fleet of carriers 31 are required to sustain an aggressive build schedule.

In the preferred fifth embodiment, a transorbital transportation pipeline is mandated to be functionally in place to build the initial orbital freight hub destinations 21, 24. When completed and operational, the freight hub 21, 24 operates in artificial gravity and serves has a cargo transfer point 26 from carrier to a space barge. Just like a terrestrial airport, massive amounts of cargo and passengers will pass daily through these portals to the Complex 1. Without a focused, aggressive and enmasse' undertaking of this freight carrier carrying capabilities, the present invention is not achievable. At FIG. 4, the construction of the initial freight hub 21 and later the initial manufacturing facility 24 that will support the building of the said complex of the present invention.

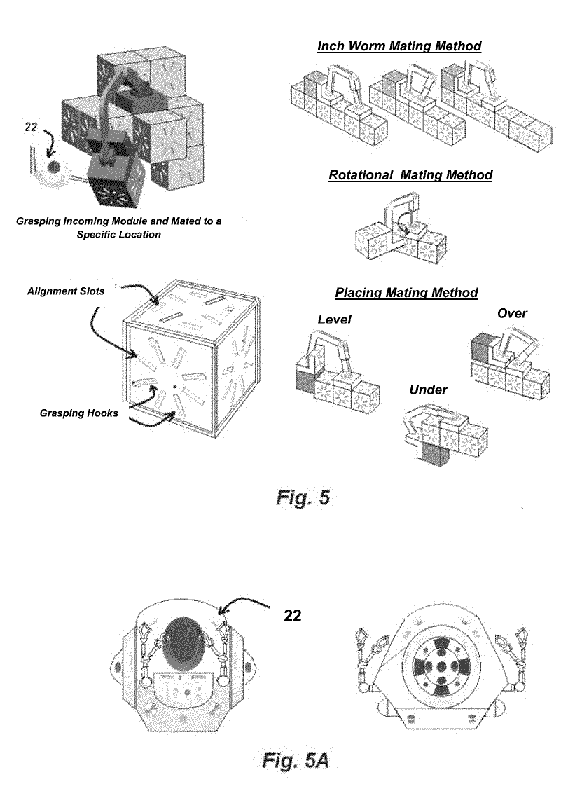

In the preferred sixth embodiment, the robotic construction devices FIG. 5 handle, positions and mates the incoming completed module from the initial manufacturing facility 23, 24. These incoming completed sub-modules 11 are floated to the desired mating location by a plurality of remotely piloted material handling drones 22 at FIG. 5A. Mating techniques follow the suggestive automatic assembly system for modular structures described in the papers of Yuzuru Terada and Satoshi Murata. Their existing autonomous-distributed control algorithms and techniques are to be tailored for mating in weightless extreme environments requiring specialized handling devices.

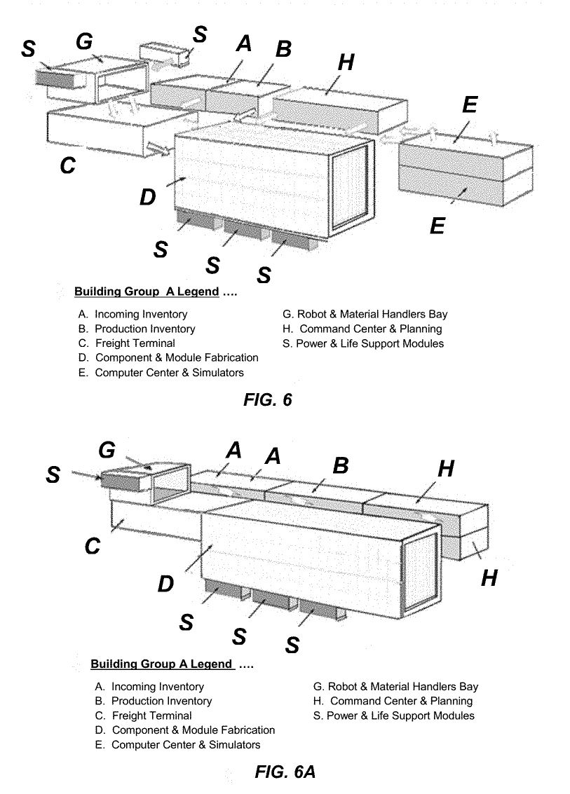

In the preferred seventh embodiment, mating and then making operational of all modules will complete Building Group A FIG. 6. The said Building Group A is responsible for receipt of all building materials from space barges 6 delivered from the space hub 21, 24, fabrication, assemblage and placing into service all the following embodiments. The addition of a space dock arm 7 and space dock test facility 8 are to be scheduled at the appropriate time.

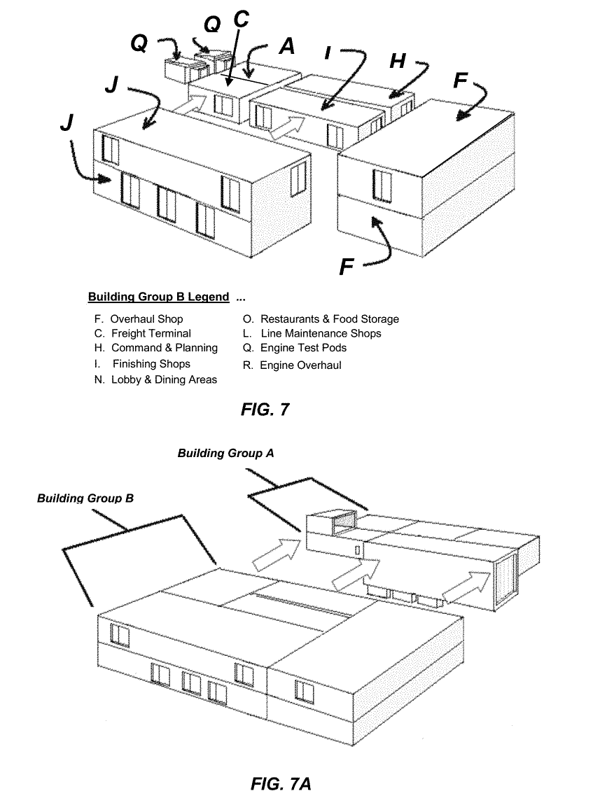

In the preferred eight embodiment, the said complex's spaces for office, maintenance shops and overhaul facility modules are mated together becoming Building Group B. FIG. 7 legend shows suggested locations of various shops in this building group. These facilities 7 are responsible for inspections, testing and maintaining all trans-orbital carriers, space barges, material handling drones, engines and military and commercial satellites. FIG. 7A shows the final mating of Building Group B to Building Group A, thus expanding the complex's activities. The Building Group B facilities the USAF requirements to cost effectively maintain, sustain, and upgrade military satellites for national security space-borne activities. In a paradigm shift in space hardware, this complex supports the currently evolving space situational awareness (SSA) paradigm in the identification of specific, discernibly threatening events that may occur too late to allow for appropriate responses. The SSA operation facilitates International Traffic in Arms Regulation (ITAR), 22 CFR Parts 120-130.

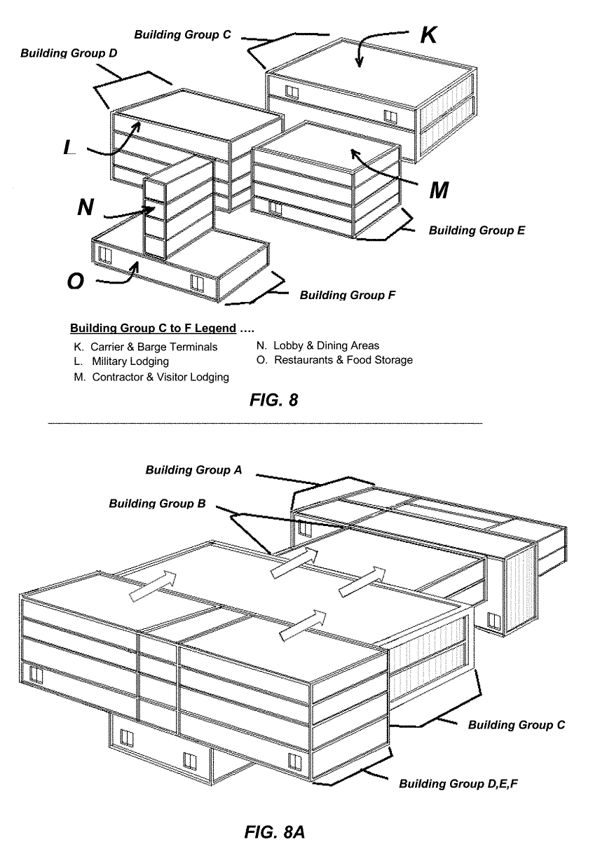

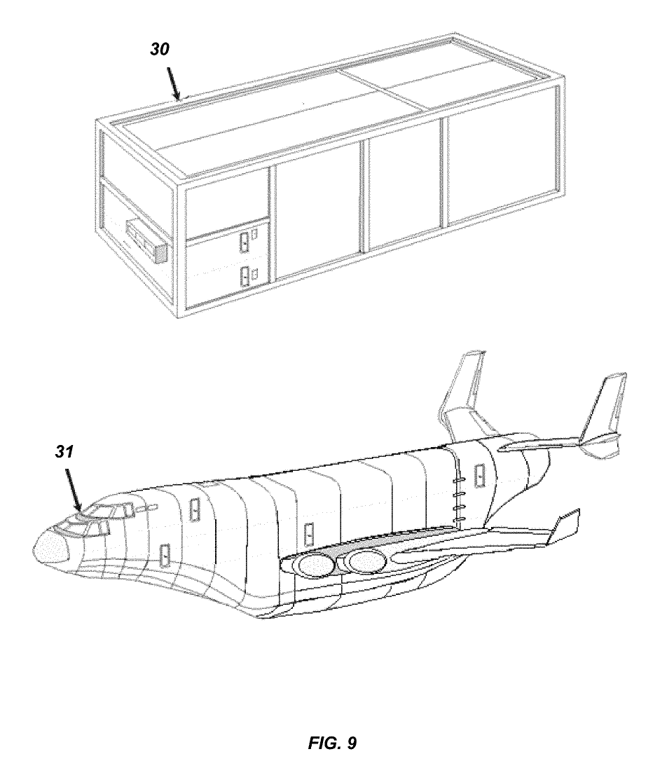

In the preferred ninth embodiment, the said complex's terminal facility legend K at FIG. 8 facilitates independently managing military, commercial trans-orbital carrier and space barge flight operations. Building Group C provides for hanger facilities. The said hanger facility is mated to Building Group B and Building Group A, thus expanding the complex's activities.

In the preferred tenth embodiment, the said complex at FIG. 8 legend shows suggested locations of various spaces in this building group. These spaces are comprised of living quarters for military personnel L displayed as Building Group D, and the contractors and transitory visitors living quarters M are displayed at Building Group E. In this said complex's, the restaurant and perishable storage facilities C and meeting room facilities N are constructed under Building Group F. FIG. 8A reflects the completed Building Groups C, D, E and F and operational thus completing the said Complex 1.

What is claimed is:

1. A method of modular construction for an orbital complex having plurality of systems, devices and apparatuses to provide for the geosynchronous orbital space sustainment of an initial and expandable complex performing limited production, fabrication, construction and maintenance with space dock services for any type of spacecraft devices, space debris removal devices or support services for other complexes.

2. A methods of claim 1 is sequenced modular mating to build said complex and incrementally place into operation. Wherein the said complex includes a combination of long term services and methods for;
DARPA-approved Compact Nuclear Fusion Power Source ;
complete life support environmental devices supporting human habitation;
complete waste management and disposal systems supporting human habitation and removal of wastes from production/maintenance services;
full service lodging and food preparation systems supporting human habitation; and
creating an artificial gravity environment support long term human habitation

3. A methods of claim 1, wherein to support long term human habitation of this or any complex or spacecraft the said complex will have module walls comprised of a thick outer wall designed to significantly reduce radiation and be a self-sealing barrier with a thinner inner wall to further reduce radiation to the inhabitants inside. The two walls are separated by a maintenance passageway to eliminate spacewalks and increase safety.

4. A methods of claim 1, wherein the said complex is further expanded to perform additional desired services for a;
space dock and testing center to provide for any type of maintenance and upgrades of existing spacecraft and expansion of existing facilities and complexes; and
shipyard facility mirroring ship construction methods, automation, and software on earth to build, outfit and test spacecraft and facility sub-modules for delivery to the Space Dock for final assemblage.

5. A methods of claim 1, wherein this said complex provides a plurality of methods to:
maintain, upgrade and assemble any satellites, and then placing the satellite back into the appropriate orbit;
test any level of any devices sub-component, mechanical, electronic or computer system where said testing can be performed in-situ at the complex or remotely from earth;
build-to-print capabilities for any mechanical, electronic and computer component or robotic device required for repair or new construction;
build-to-print capabilities for fabrication, testing and programming any robotic material handling drone, robotic device or automated production line devices that would be controlled in-situ at the complex or remotely from earth; and
build-to-print capabilities for the fabrication, maintenance, upgrading, assemblage, testing and programming of any type of advanced space propulsion.

6. A methods of claim 1, wherein the said complex provides methods to receive, refuel, and maintain any trans-orbital freight or passenger carrier or space barge

7. A methods of claim 1, wherein the said complex provides methods for mating an advanced research and development facility for military, government and commercial purposes

8. A methods of claim 1, wherein the said complex provides methods for continuous expansion of the complex comprising claim 2 attributes.

9. A methods of claim 1, wherein the said complex provides propulsion methods to support planetary and deep space exploration.
